(19) United States
(12) Patent Application Publication
(10) Pub. No.: US 2021/0182976 A1
(43) Pub. Date: Jun. 17, 2021

(54) METHODS AND SYSTEMS FOR SOCIAL MEDIA RECOMMENDATIONS ENGINES

(71) Applicant: KoTrie, San Francisco, CA (US)

(72) Inventor: Irina Poslavsky, San Francisco, CA (US)

(21) Appl. No.: 16/790,545

(22) Filed: Feb. 13, 2020

Related U.S. Application Data
(60) Provisional application No. 62/947,446, filed on Dec. 12, 2019.

(51) Int. Cl. G06Q 50/00; G06F 16/9535; G06F 16/9538; G06Q 30/06; G06Q 20/08; G06Q 50/12; G06Q 50/14; G06Q 50/30; G06N 3/04; G06N 3/08; G10L 15/18; G10L 15/22

(52) U.S. Cl. CPC G06Q 50/01; G10L 15/22; G06F 16/9538; G06Q 30/0631; G06Q 30/0633; G06Q 30/0641; G06Q 20/0855; G06Q 50/12; G06Q 50/14; G06Q 50/30; G06N 3/0427; G06N 3/08; G10L 15/1815; G10L 15/1822; G06F 16/9535

(57) ABSTRACT

The present disclosure provides methods and systems for generating a gift recommendation for a user of a social network. A method can comprise obtaining data about the user. Next, the data about the user can be processed with an artificial intelligence algorithm to predict a plurality of gifts relevant to the user. Next, in a graphical user interface, a list of the plurality of gifts can be presented to one or more other members of the social network who are associated with the user. Next a payment interface configured to enable the one or more other members to pay a cost of the gift can be provided. Next, upon receiving payment from the one or more other members, an order can be automatically placed for the gift with an online merchant that offers the gift.

### CROSS REFERENCE

This application claims the benefit of U.S. Provisional Patent Application No. 62/947,446, filed Dec. 12, 2019, which is entirely incorporated herein by reference.

### BACKGROUND

As social media and online interaction increasingly dominate the social lives of users, the number of relationships a person is a part of has increased along with the pressure to maintain established relationships. One area where an enlarged social network can cause issues is gift giving. Knowing the gift preferences of each person in one's social circle may be difficult, and shopping for such gifts can be time consuming.

Effectively leveraging online social networks can be difficult, particularly when considering interactions with network members beyond those directly connected to a user. A lack of knowledge about what is happening in a person's extended social sphere can result in the person being unable to engage with potential connections, even if the person wanted to. Effectively facilitating interactions between these connections provides an opportunity for a gift economy focused on giving and improving the relationships of its members.

### SUMMARY

Recognized herein is the need for a method for generating gift ideas for connections on a social media network and purchasing those gifts. Further recognized herein is the need for a method to connect people who can offer services and favors to one another but who may not necessarily know of each other's needs. Additionally recognized herein is the importance of selecting a proper gift at a proper time to the satisfaction of the recipient, along with the importance of minimizing work used to select the gift.

In an aspect, the present disclosure provides a method for generating a gift recommendation for a user of a social network, comprising: (a) obtaining data about the user, which data comprises at least messages and associations of the user on the social network; (b) processing the data about the user with an artificial intelligence algorithm to predict a plurality of gifts relevant to the user; (c) presenting, in a graphical user interface, a list of the plurality of gifts to one or more other members of the social network who are associated with the user, which list is configured to enable the one or more other users to select a gift of the plurality of gifts; (d) providing a payment interface configured to enable the one or more other members to pay a cost of the gift; and (e) upon receiving payment from the one or more other members, automatically placing an order for the gift with an online merchant that offers the gift.

In some embodiments, the associations comprise one or more of likes, page views, interactions, or check-ins on the social network. In some embodiments, the messages comprise posts and private messages on the social network. In some embodiments, the posts comprise images. In some embodiments, the data further comprises audio and video chats on the social network. In some embodiments, the data comprises survey data from the user. In some embodiments, the artificial intelligence algorithm comprises a natural language processing algorithm. In some embodiments, the payment interface is configured to charge the one or more other users an equal amount for the gift. In some embodiments, (c) comprises selecting the one or more other users based on a relationship to the user, an interaction with the user, or a history of gift giving. In some embodiments the user data comprises a wish list generated by the user.

In another aspect, the present disclosure provides a system comprising: a data acquisition unit configured to obtain data about a user of a social network, which data comprises at least messages and associations of the user on the social network; a gift recommendation engine configured to (i) process the data about the user with an artificial intelligence algorithm to predict a plurality of gifts relevant to the user and (ii) present, in a graphical user interface, a list of the plurality of gifts to one or more other members of the social network who are associated with the user, which list is configured to enable the one or more other users to select a gift of the plurality of gifts; and a payment unit configured to (i) provide a payment interface configured to enable the one or more other users to pay a cost of the gift and (ii) upon receiving payment from the one or more other users, automatically place an order for the gift with an online merchant that offers the gift.

In another aspect, the present disclosure provides one or more non-transitory computer storage media storing instructions that are operable, when executed by one or more computers, to cause the one or more computers to perform operations comprising: (a) obtaining data about a user of a social network, which data comprises at least messages and associations of the user on the social network; (b) processing the data about the user with an artificial intelligence algorithm to predict a plurality of gifts relevant to the user; (c) presenting, in a graphical user interface, a list of the plurality of gifts to one or more other members of the social network who are associated with the user, which list is configured to enable the one or more other users to select a gift of the plurality of gifts; (d) providing a payment interface configured to enable the one or more other users to pay a cost of the gift; and (e) upon receiving payment from the one or more other users, automatically placing an order for the gift with an online merchant that offers the gift.

In another aspect, the present disclosure provides a method for connecting users of a social network, comprising: (a) receiving, from the social network, an indication that a first user intends to travel to a location; (b) determining that a second user of the social network lives in the location, wherein the first user and the second user are associated with each other on the social network (i) directly or (ii) through one or more other users of the social network, and wherein the second user has offered a service on the social network; and (c) connecting the first user and the second user on the social network to enable the second user to perform the service for the first user.

In some embodiments, the connecting comprises asking a person of the one or more other people if the person will connect the user and the member. In some embodiments, the connecting comprises introducing the member and the user via a social media platform. In some embodiments, the connecting comprises using an artificial intelligence algorithm to determine a compatibility of the member and the user and connecting the user to the member if the compatibility is above a threshold value. In some embodiments, the compatibility is based at least in part on one or more factors selected from the group consisting of personal beliefs, shared hobbies, shared interests, proximity within the extended social network, and previous interactions of the user and the member. In some embodiments, the factors are determined using an artificial intelligence algorithm and social media data of the user and the member. In some embodiments, the service is selected from the group consisting of providing transportation, providing a meal, providing accommodations, and providing a tour of the location. In some embodiments, the gift is selected or purchased by a third-party concierge.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a flow chart of an example process for generating a gift recommendation for a user of a social network.

FIG. 2 is a flow chart of an example process for connecting users of a social network.

FIG. 3 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “artificial intelligence,” as used herein, generally refers to machine intelligence that includes a computer model or algorithm that may be used to make a recommendation or prediction, classify data, or otherwise take an action that maximizes the chance of achieving of one or more goals of the artificial intelligence. Artificial intelligence may be or include a machine learning algorithm. The machine learning algorithm may be a trained machine learning algorithm, e.g. a machine learning algorithm trained on historical data. Such a trained machine learning algorithm may be trained using supervised, semi-supervised, or unsupervised learning process. Examples of machine learning algorithms include neural networks, support vector machines, and reinforcement learning algorithms.

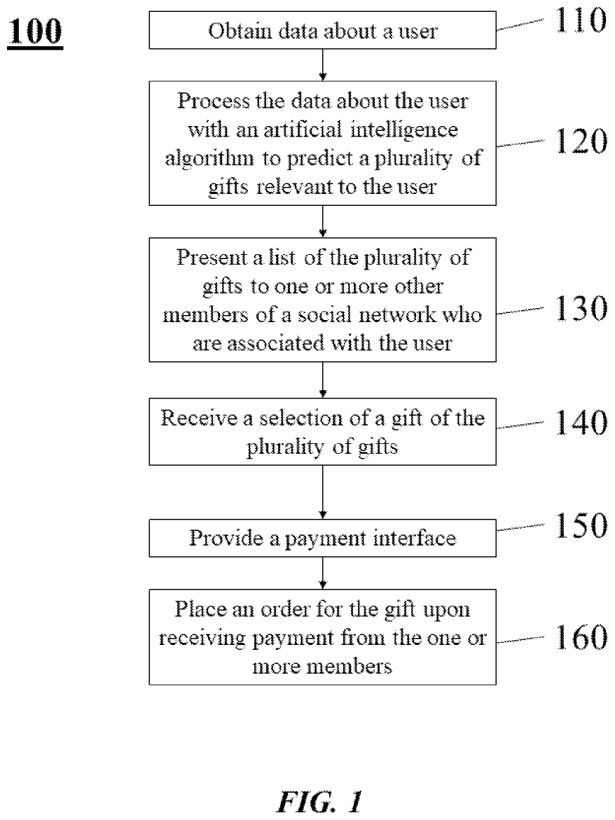

FIG. 1 is a flow chart of an example process 100 for generating a gift recommendation for a user of a social network. The process 100 can be performed by a system of one or more appropriately-programmed computers in one or more locations. For example, the process 100 can be performed by one or more servers that host the social network and one or more user devices (e.g., mobile devices or laptop computers) that run user-instances of the social network. The social network may be configured to facilitate interactions between one or more users. The interactions may be an exchange of one or more messages. The one or more messages may be public posts (e.g., status updates, image posts), comments on posts, post interactions (e.g., likes, reactions), shares (e.g., posting a same post on the profile of the user), private messages (e.g., chat sessions), or any combination thereof. A user of the one or more users may have an association with other users. The associations may be friends (e.g., two users who have mutually agreed to be linked on the social network), friends-of-friends (e.g., a user and a friend-of-a-friend are linked by one other user who is friends with both the user and the friend-of-a-friend), profile interactions (e.g., liking a user's page, following a user), or any combination thereof. A plurality of users may associate in a group. The group may facilitate communication and sharing between the users who are members of the group. The social network may comprise pages made by companies. For example, a brand can make a profile for news and information about the brand. The social network may be a private social network. The private social network may be configured to not publicly display user information. The private social network may allow users to create associations with invited other users using unique invitations. For example, a first user can give an identifier unique to the first user to a second user that enables the second user to find the profile of the first user. The social network may be a public social network. The public social network may permit interactions and views from users who are not members of the social network, who are not connected with the owner of a page, or the like. A user may decide if their profile is a private or public profile. The user may establish an account with the social network. Establishing the account may comprise the user providing information via an interface (e.g., a webpage). The information may comprise biographic information (e.g., age, residence location, etc.), login information (e.g., a username, an email address, a password), interests of the user (e.g., hobbies, style preferences, interest in sports, etc.), or any combination thereof.

The method 100 may comprise obtaining data about a user (110). The data may comprise messages and associations of the user. Alternatively or additionally, the data may be biographical data about the user provided by the user. The system may obtain such biographical data directly from the user's account on the social network. The data may also comprise survey or questionnaire data. The system may obtain the survey or questionnaire data using one or more surveys or questionnaires. For example, a user can complete a survey on what kinds of cloths the user prefers, and the preferences can be saved as related to the account of the user. The survey or questionnaire may be a game wherein the user makes selections that are related to the user's preferences. For example, a user can be asked to decorate a virtual space, and the selections made by the user can be associated with the user's account as data about the user. The data may be a wish list generated by the user. For example, the user can curate a list of gifts that they are interested in. The wish list may comprise information regarding the gifts on the list, the occasion the user would like to receive the gift for (e.g., a birthday gift, an anniversary gift), the order of preference of the gifts, or the like. The wish list may be used as a validation set for an artificial intelligence algorithm as described elsewhere herein. The use of the wish list as a validation set can improve the accuracy of the artificial intelligence algorithm.

The system may obtain the data from one or more posts of the user. The posts of the user may be text posts, photo posts, video posts, or any combination thereof. The data may be obtained from one or more online interactions of a user. The one or more online interactions may be chats, calls, browsing histories, or any combination thereof. The chats may be between two or more users of a social media platform. For example, the chat may be a chat between a user and his friend during which the user expresses interest in seeing a band perform. The calls may be calls between two or more users of a social media platform. The calls may be made using a calling functionality of the social media platform or another calling application. The calls may be audio calls, video calls, or a combination thereof. The calls may be analyzed using a vocal processing artificial intelligence algorithm. For example, a user in a phone call can mention that the user is interested in a particular model of cell phone, and the voice processing algorithm can associate that interest with that user. The artificial intelligence algorithm may use one or more pieces of metadata related to the calls. The pieces of metadata may be call duration, time of day of the call, which user initiated the call, the frequency of calls between the users, and the like.

The browsing histories may be browsing histories taken from a mobile device (e.g., a tablet, a cellular telephone, a personal digital assistant), a computer (e.g., a laptop computer, a desktop computer), or the like. The browsing histories may be formed by a built-in functionality of an interne browser (e.g., the history function of a browser), tracking links (e.g., personalized links to other pages where accessing the link tracks where the link originated), tracking elements (e.g., tracking pixels, cookies, flares), or any combination thereof. The browsing histories may be enumerated on a server. For example, a user clicks an advertising link that is personalized to that user with a unique string of characters as part of the link. In this example, when the link resolves, the host is able to record on the server that the link originated from that user and associate the product the link was directed to with the user. The browsing histories may comprise identity of pages viewed (e.g., the exact page that was viewed), categories of pages viewed (e.g., online retail, electronics), duration of page views, frequency of page views, time of page view, and the like.

The data may be obtained from a location history of the user. The location history may track locations the user has been and obtain data about one or more interests of the user. The location history may be based on a mobile device (e.g., a cellular telephone) location history. The location history may be processed using an artificial intelligence algorithm. For example, if a user spends time in a particular shop, as recorder by the location service of the user's cellular telephone, the process can determine an interest of the user in goods sold by the shop. In another example, the location of a user within a larger department store can be used to determine the types of items the user is interested in, as well as brands the user prefers. The location history may be used to determine if a user is in contact with another user. For example, if two users are in the same location every Tuesday, the artificial intelligence algorithm can associate those users as friends. The data may be associations of the user with a social network. The interactions of the user may be likes, shares, page views, interactions (e.g., ‘pokes’, messages), check-ins, or the like.

The method 100 may further comprise processing the data about the user using an artificial intelligence algorithm to predict a plurality of gifts relevant to the user (120). The artificial intelligence algorithm can take one or more types of data as input. For example, the artificial intelligence algorithm can use data gathered from a user's chat sessions, browsing history, and location history to predict a plurality of possible gifts. The artificial intelligence algorithm may predict 1, 2, 3, 4, 5, 10, 15, 20, 25, 50, 100, or more gifts as relevant to the user. The artificial intelligence algorithm may generate a list of gifts relevant to the user. The list may be updated. For example, a list of relevant gifts can be generated, and the list can be changed to reflect new data obtained about the user. The artificial intelligence algorithm may generate a rating of the relevance of the gift to the user. For example, if the user spends a lot of time browsing a particular brand's website and a lot of time in that brand's store, the artificial intelligence algorithm can give a gift from that brand a higher rating than a similar gift from another brand. The data may be processed using a dichotomous key hierarchical organization method. For example, a user's interest in fashion can be organized by enumerating the subsets of fashion that the user is interested in. In this example, a user interested in jeans made by brand Y can have their interest classified as a tree structure of fashion-clothing-leg clothing-pants-jeans-brand Y jeans. Classifying using a dichotomous key hierarchical organization method can generate data in a format that is easily analyzable by artificial intelligence algorithms. The data obtained in operation 110 may improve the functioning of the artificial intelligence algorithms. For example, the quality and breadth of data collected using the social network can improve the predictions made by the artificial intelligence algorithms as compared to other data sources. The use of artificial intelligence algorithms may enable gift predictions that are not reasonably generated by other methods. For example, an artificial intelligence algorithm can consider a number of data points that would not be practicable using traditional computer algorithms, let alone by a human. In another example, the artificial intelligence algorithm can process gift recommendations for an entire social network of users, a much larger number of people than possible by a person. Additionally, the data obtained can improve the timeliness of the gift that is selected. For example, a user who has increased their searches for a new facial moisturizer can be identified by the data obtained in operation 110. In this example, a gift of a facial moisturizer can be a better gift at that time than other gifts may be. A person may not be able to track this kind of data, and certainly not on the scale that can be performed by the methods and systems described herein.

The posts of the user may be processed using an artificial intelligence algorithm. For example, a user can post a message on a fan page of a particular brand of shoes saying, “These are the best shoes,” and an NLP algorithm can ascertain that the user prefers that brand of shoes. The posts of the user may be processed using one or more computer vision algorithms. The computer vision algorithms may process images and/or video to determine the identity of an object in the images and/or video. For example, a computer vision algorithm can be used to identify the brand and style of clothing a user is wearing in a video the user posted and the artificial intelligence algorithm can associate a brand and/or style preference to the user based on what the user was wearing.

The messages of the user may be processed using an artificial intelligence algorithm. For example, the NLP algorithm can process a chat in which a user mentions a band to determine that the user is interested in that band, as well as that the user is interested in that genre of music. In another example, a chat can be formed to plan a surprise birthday party for another user. In this example, the NLP algorithm can determine the purpose of the chat using the name of the chat and the content of the messages, and then associate that all of the members of the chat are close to the other user and that the members of the chat may be interested in purchasing a gift for the other user. The chats may be between a user and an artificial intelligence algorithm. For example, a user can ask an artificial intelligence based chatbot for restaurant recommendations. In this example, the chatbot can utilize data related to the user's eating habits and preferences to generate a ranked list of recommendations. The chats may comprise private messages of a user.

Artificial intelligence algorithms implemented on a device of a user or a remote server can be used to implement processes as described herein. For example, an artificial intelligence algorithm can be configured to read social media posts by one or more users on a social media network. A different artificial intelligence algorithm can be trained to process various interactions of a user to determine an interest of the user and a gift related to that interest. Such an artificial intelligence algorithm or computer vision algorithm can determine a user is planning to travel to a location. Other artificial intelligence algorithms can be configured to process a compatibility score between users of a social media network. Still other artificial intelligence algorithms can be configured to connect users with items to sell or trade.

The artificial intelligence algorithm may be a machine learning algorithm. The machine learning algorithm may be a supervised, semi-supervised, or unsupervised machine learning algorithm. A supervised machine learning algorithm can be trained using labeled training inputs, e.g., training inputs with known outputs. The training inputs can be provided to an untrained or partially trained version of the machine learning algorithm to generate a predicted output. The predicted output can be compared to the known output, and if there is a difference, the parameters of the machine learning algorithm can be updated. A semi-supervised machine learning algorithm can be trained using a large number of unlabeled training inputs and a small number of labeled training inputs. An unsupervised machine learning algorithm, e.g., a clustering algorithm, can find previously unknown patterns in data sets without pre-existing labels.

One example of a machine learning algorithm that can perform some of the functions described above, e.g., process user activity to determine an appropriate gift for the user, is a neural network. Neural networks can employ multiple layers of operations to predict one or more outputs, e.g., gift recommendations, from one or more inputs, e.g., posts, chat records, calls, browsing histories. Neural networks can include one or more hidden layers situated between an input layer and an output layer. The output of each layer can be used as input to another layer, e.g., the next hidden layer or the output layer. Each layer of a neural network can specify one or more transformation operations to be performed on input to the layer. Such transformation operations may be referred to as neurons. The output of a particular neuron can be a weighted sum of the inputs to the neuron, adjusted with a bias and multiplied by an activation function, e.g., a rectified linear unit (ReLU) or a sigmoid function.

Training a neural network can involve providing inputs to the untrained neural network to generate predicted outputs, comparing the predicted outputs to expected outputs, and updating the algorithm's weights and biases to account for the difference between the predicted outputs and the expected outputs. Specifically, a cost function can be used to calculate a difference between the predicted outputs and the expected outputs. By computing the derivative of the cost function with respect to the weights and biases of the network, the weights and biases can be iteratively adjusted over multiple cycles to minimize the cost function. Training can be complete when the predicted outputs satisfy a convergence condition, such as obtaining a small magnitude of calculated cost.

Types of neural networks include feed-forward neural networks, convolutional neural networks (CNNs), recurrent neural networks (RNNs), long-short term memory (LSTM) networks, autoencoders, and the like. Other examples of machine learning algorithms that can be used to process user interactions with a social media network are regression algorithms, decision trees, support vector machines, Bayesian networks, clustering algorithms, reinforcement learning algorithms, and the like.

In some cases, the artificial intelligence algorithm may be a natural language processing algorithm that is configured to process text inputs from the social networks described herein. The natural language processing algorithm may be a rule-based algorithm or a statistical model (e.g., a machine learning algorithm). The natural language processing algorithm may parse or segment text inputs, extract context from text inputs (e.g., the author's interests or gift preferences), or identify relationships or sentiments in the text inputs. In some cases, the natural language processing algorithm may be or include a speech recognition model that converts speech to text. Such a speech recognition model may rely on RNNs or LSTMs to analyze a time series of speech inputs.

The method 100 may further comprise presenting a list of the plurality of gifts to one or more other members of a social network who are associated with the user (130). The list may be a list as described above. The list may be able to be searched, ranked, filtered, sorted, or the like. The searching may be by keyword, category, or the like. The filtering and/or sorting may be by price, relevance rating, category, relevance to a member of the one or more other members of the social network, and the like. For example, a member of the one or more other members can sort the list by ascending price and filter the list to only show gifts that are also relevant to that member. In this example, the member prefers gifts that they themselves are interested in, so filtering by relevance to the member improves the quality of the list presented to the member. The list may be a different list for each member of the one or more other members. For example, a list that has been pre-filtered to only have gifts under $25 can be presented to a younger member while a list of the most relevant gifts, regardless of cost, can be presented to an older member. In another example, the list of less expensive gifts can be presented to a member who is not as closely associated with the user while a member who is a close friend of the user can be presented the list of the most relevant recommendations.

The association of the one or more members with the user may comprise one or more of post interactions, page views, interactions, check-ins on the social network, duration of interaction, or any combination thereof. The associations may be associations of the user with the one or more members or associations of the one or more members with the user. For example, the user liking a photo of a member can be an interaction. In another example, a member checking in with the user can be an interaction. The post interactions may be likes, comments, shares, and the like. The page views can comprise information such as the frequency of page views, the duration of page views, and the fraction of page views that result in a post interaction. The interactions may comprise messages, chat conversations, video conversations, audio conversations, location proximity (e.g., the user and the member being in the same geographical area at the same time), and the like. The duration of interaction may comprise information such as the length of an association on the social media platform (e.g., the length of a friendship). The one or more other members may be selected based on a relationship to the user, an interaction with the user, a history of gift giving, or any combination thereof. The relationship may be a familial relationship (e.g., parent, sibling, etc.), a business relationship (e.g., boss, coworker), a friendship, or the like. The interaction with the user may be one or more associations as described elsewhere herein. The history of gift giving may be a history of the member giving gifts to the user, the user giving gifts to the member, or the member giving gifts to people other than the user. For example, a member who has a history of giving gifts to their coworkers on the social media platform can be presented a list of gifts relevant to a new coworker they just started working with.

The method 100 may further comprise receiving a selection of a gift of the plurality of gifts (140). The selection may be made by one or more of the members. The list may be configured to enable the one or more other members to select a gift of the plurality of gifts. The one or more members may select one or more gifts of the plurality of gifts. The one or more members may vote on which gift of the plurality of gifts to select. For example, five members vote to select a handbag as the gift while four members vote for a watch as the gift. In this example, the members can select the majority gift, or the four members can choose to purchase the watch while the other five purchase the handbag. The one or more members may pledge an amount of money towards a gift of the plurality of gifts. For example, a member can pledge $50 towards a $100 pair of shoes. In this example, other members can pledge the remainder of the $100 to purchase the gift. The members may pledge an amount of money to a plurality of gifts. For example, a member can pledge $25 to each of the top five ranked gifts. The system may be configured to charge a member for one pledge. For example, the member who pledged $25 to each of the top five gifts can be charged once when one gift reaches pledges equaling the cost of the gift. The selection may be a selection of a gift on the wish list of the user.

The one or more members may assign one member of the one or more members to pick a gift. For example, a plurality of member can decide that the user's spouse will pick the gift the members will contribute to. The one or more members may agree or disagree with the gift picked by the one member. For example, the plurality of members can agree with the selection of the user's spouse. In another example, the plurality of members can disagree with the selection and select a different member to choose a gift. The cost of the gift may be equally divided between the plurality of members. The plurality of members may send money to the assigned member to pay for the gift. The sending the money may be via the social media platform. For example, the plurality of members can send money to the member who selected the gift using a payment portal on the social media platform. The member who picked the gift may purchase the gift for the user. The member may designate another person to purchase the gift. For example, a user's spouse who selected a gift can have another member pay for and receive the gift so that the user is surprised by it. The users may send money to a payment processor that is part of the social media network. For example, the members can each input credit card information into the social media network, where the payment processing algorithm can charge the members equally. In this example, the payment processing algorithm can place the order with an online merchant and have the gift shipped directly to the user. In another example, the gift can be shipped to a member who can subsequently give the gift to the user on behalf of the plurality of members.

The method 100 may further comprise providing a payment interface (150). The payment interface may be configured to enable the one or more other members to pay a cost of the gift. The payment interface may be configured to accept payment using one or more payment applications. The one or more payment applications may be applications such as Square®, PayPal®, Venmo®, Stripe®, Google Pay®, Samsung Pay®, Apple Pay®, bank transfer, or any combination thereof. The payment interface may be configured to accept payment using credit cards, debit cards, cryptocurrencies, or any combination thereof. The payment interface may be configured to charge the one or more other members an equal amount for the gift. Alternatively, the payment interface may be configured to charge different amounts to each member of the one or more other members. The payment interface may use information about the one or more other members such as age, relationship to the user, occupation, gift giving history, or any combination thereof to determine how much each member of the one or more other members pays. For example, the artificial intelligence algorithm can review the occupations of each of the members purchasing the gift, determine an average salary for each of the occupations, and divide the cost of the gift in proportion to the average salary of each member's occupation.

The method 100 may further comprise placing an order for the gift upon receiving payment from the one or more members (160). The placing of the order may be automatic. The placing of the order may be with an online merchant that offers the gift. The online merchant may ship the gift to the user. The online merchant may ship the gift to a member of the one or more other members. The placing the order may be performed by a concierge service. For example, once a gift is selected, the members can transmit that gift to a third party who purchases the gift and arranges its delivery. The concierge service may select the gift independently of the members. For example, the concierge service can receive the list of gifts generated by the artificial intelligence algorithm and select a gift form it based on the budget given to the concierge by the members.

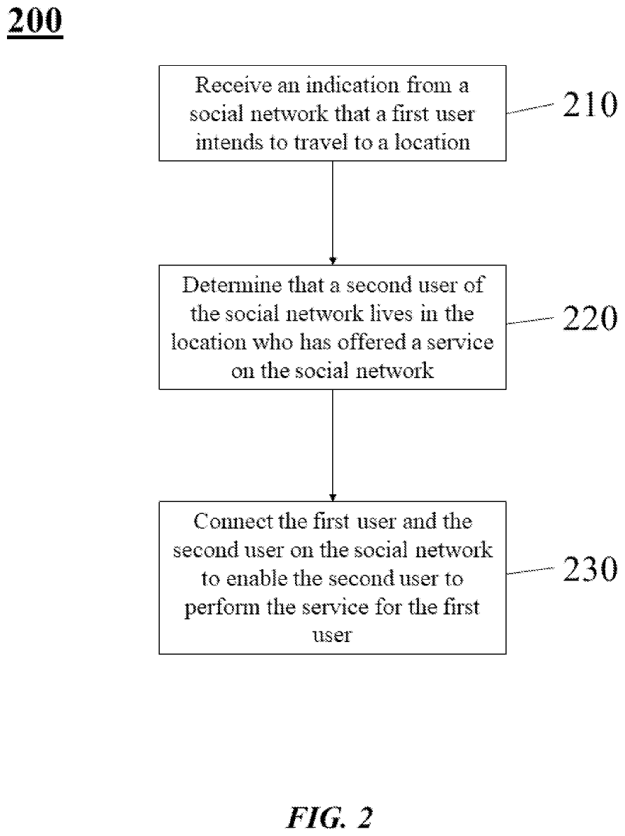

FIG. 2 is a flow chart of an example process 200 for connecting users of a social network. The process 200 can be performed by a system of one or more appropriately-programmed computers in one or more locations. For example, the process 200 can be performed by one or more servers that host the social network and one or more user devices (e.g., mobile devices or laptop computers) that run user-instances of the social network

The method 200 may comprise receiving an indication from a social network that a first user intends to travel to a location (210). The indication may be taken from interactions of the first user with the social network. The interactions may comprise posts on the social network, chats, messages, calls, browsing histories, or other interactions as described elsewhere herein. The location may be a location where other users of the social network live. The location may be a location where other users of the social network are also traveling to.

The method 200 may comprise determining that a second member of the social network lives in the location who has offered a service on the social network (220). The first user and the second member may be associated with each other on the social network. The association may be direct (e.g., the first and second member are friends) or through one or more other users of the social network (e.g., the user and second member are friends-of-friends). The second member may have offered a service to the first user on the social network. The service may be providing transportation (e.g., a ride from an airport to a hotel), providing a meal (e.g., cooking a meal for the first user, taking the first user out to a local restaurant), providing accommodations (e.g., allowing the first user to sleep in a guest room of the second member's home), providing a tour of the location (e.g., taking the first user to local attractions), or any combination thereof. The second member may have made a general offer of the service. For example, the second member can post that they are willing to take any of their friends or friends of friends out to dinner if their friends are in town. The second member may be asked to provide the service by another member. The other member may have a connection to the first user. For example, the first user can be the brother of another member, where the other member asks the second member (a friend) if their brother can stay on the second user's couch.

The method 200 may comprise connecting the first user and the second member on the social network to enable the second user to perform the service for the first user (230). The connecting may comprise asking a person of the one or more other people if the person will connect the user and the second member. For example, the social network can determine that a first user is traveling to a location where the member (a friend of one of the first user's friends) lives. In this example, the social network can ask the first user's friend if they want to introduce the first user to the member, and if they want to recommend an activity for the two of them to do together. The connecting may comprise introducing the member and the user via the social media platform. For example, the social media platform can start a group chat between the user and the member so that the user and the member can coordinate a time for the member to pick the user up from the airport. The introducing the user and the member may comprise starting a messaging thread, scheduling a video conference, or the like. The response of the person of the one or more people may be used to further train the artificial intelligence algorithm. For example, if the person declines to introduce the user and the member because the person believes they are incompatible, the artificial intelligence algorithm can update the model and weights to reflect the assessment of the person.

The connecting may comprise using an artificial intelligence algorithm to determine a compatibility of the member and the user. The artificial intelligence algorithm may connect the user and the member if the compatibility is above a threshold value. The compatibility may be based at least in part on one or more factors including personal beliefs, shared hobbies, shared interests, proximity within said extended social network, previous interactions of the user and the member, or any combination thereof. The factors may be determined using an artificial intelligence algorithm and social media data of the user and the member. The social media data may be social media data as described elsewhere herein such as, for example, posts, interests, and messages. The artificial intelligence algorithm may improve performance of the method. The artificial intelligence method may enable previously untenable numbers of connections to be reviewed in connecting the first user and the second member. For example, a user with 500 friends, each of whom have 500 more friends would generate 250,000 connections that could be connected. This number of connections would not be possible for a human to review, highlighting at least some of the improvements of the present method.

Alternatively, the system can determine that a second user of the social network is also traveling to the location. For example, a user is traveling to Paris at the same time as another user is. The social network may introduce the user and the second user and provide recommendations of accommodation the user and the second user can share. For example, a user and a second user are both independently planning to travel to Hong Kong, so the artificial intelligence algorithm can introduce the user and the second user and provide a hotel that the user and second user can share for less than the cost of each staying on their own.

The processes of FIG. 1 or 2 can be performed by one or more computing devices. The computing devices can be servers, desktop or laptop computers, electronic tablets, mobile devices, or the like. The computing devices can be located in one or more locations. The computing devices can have general-purpose processors, graphics processing units (GPU), application-specific integrated circuits (ASIC), field-programmable gate-arrays (FPGA), or the like. The computing devices can additionally have memory, e.g., dynamic or static random-access memory, read-only memory, flash memory, hard drives, or the like. The memory can be configured to store instructions that, upon execution, cause the computing devices to implement the functionality of the subsystems. The computing devices can additionally have network communication devices. The network communication devices can enable the computing devices to communicate with each other and with any number of user devices, over a network. The network can be a wired or wireless network. For example, the network can be a fiber optic network, Ethernet® network, a satellite network, a cellular network, a Wi-Fi® network, a Bluetooth® network, or the like. In other implementations, the computing devices can be several distributed computing devices that are accessible through the Internet. Such computing devices may be considered cloud computing devices.

### Social Media Marketplace

Disclosed herein are methods and systems configured to provide a marketplace for buying/selling and/or trading goods between users of a social network. The method can be implemented on one or more appropriately programmed computers in one or more locations.

The marketplace may be configured to receive postings of one or more users about one or more items the users have or want to purchase. For example, a user can post that they have a car seat that their child has grown out of, and that they want to sell it. In another example, the user can post that they want to trade a car seat that their child has grown out of for sports equipment. The marketplace may be configured to accept open ended requests (e.g., “How much will someone pay me for this dress?”) or closed ended requests (e.g., “I am selling this keyboard for $100.”). The postings may comprise text, images, videos, or any combination thereof.

The marketplace may be configured to use an artificial intelligence algorithm to sort and filter the marketplace postings that are shown to a particular user. For example, a user who has been posting about the upcoming birth of their child can be shown postings of other users selling infant apparel. In another example, a user who has posted about how quickly their child is growing can be shown posts of others trying to buy clothing the user's child has grown out of.

The marketplace may be configured to show postings from a subset of posters. The subset of posters may comprise users within a certain social distance of the users looking at the marketplace (e.g., the posters are friend or friends of friends of the user). The user may be able to filter the posts to show posts by others who are within a certain distance of the user. An artificial intelligence algorithm may be used to filter the posts. For example, an artificial intelligence algorithm can track a preference of a user to purchase items from their friends and prioritize showing the user posts made by the user's friends.

The marketplace may be configured to facilitate a request of a user for a particular local item. The marketplace may use an artificial intelligence algorithm to facilitate the request. For example, a first user wants a particular type of pottery that is produced in one city. In this example, the artificial intelligence algorithm can determine an intension of a second user, who is a friend of the first user, to travel to the city and then permit the first user to contact the second user and ask the second user to purchase the pottery. In another example, a user can post that they want a limited run item that is not available in their area. In this example, the artificial intelligence algorithm can determine that a friend of a friend of the user lives in an area where the item is available and connect the user with the friend of a friend. The artificial intelligence algorithm may be configured to connect a first user making the request to a second user who is most likely to complete the request (e.g., has completed requests for others in the past). The presence of the artificial intelligence algorithm can improve the functioning of the marketplace by filtering and selecting listings to display with an improved accuracy as compared to other methods.

The marketplace may provide a money transfer portal to facilitate a payment. The payment may be in response to a sale of an item or in response to a user accepting a request to purchase something local to that user. The money transfer portal may hold a first user's money to be used by a second user. For example, a first user wanting to purchase a $150 piece of art that is sold in a different city can be charged $150 by the money transfer portal, and the money can be kept in an account of the user on the portal. In this example, when a second user agrees to purchase the art, the second user can pay for the art directly with the first user's money (e.g., the money is transferred from the portal to the shop the art was bought in). In this example, the first user can additionally prepay for shipping of the item to the first user.

### Social Network-Based Recommendations

Disclosed herein are methods and systems configured to provide users of a social network with artificial intelligence powered recommendations for services. The method can be implemented on one or more appropriately programmed computers in one or more locations.

The artificial intelligence algorithm may be configured to determine a connection between a user and a service provider in the social network. For example, the artificial intelligence algorithm can input a user who posts about needing an electrician and determine an electrician on the social network who is the closest to the user out of the plurality of available electricians. The artificial intelligence algorithm may generate one or more suggestions of service providers. The suggestions may be based on more data points and possibilities that would be possible if not for the artificial intelligence algorithm. The artificial intelligence algorithm may rank the one or more suggestions by one or more factors. The factors may be factors such as proximity in the social network to the user, past interactions with the user, ratings, known costs, and the like.

The services may be services users of the social network can offer (e.g., the user is a plumber) or recommendations of the users for services provided by others (e.g., the user knows a plumber). The services may be, for example, retail services (e.g., where to purchase a car), cosmetic services (e.g., barber, beautician), construction services (e.g., electrician, plumber, contractor), software development (e.g., website production, app development), legal services, real estate services, accounting services, consulting services, and the like.

### Revival of Derelict Messaging Threads

Disclosed herein are methods and systems configured to provide a way to restore unused messaging threads. The method can be implemented on one or more appropriately programmed computers in one or more locations.

The method may comprise an artificial intelligence algorithm. The artificial intelligence algorithm may be configured to track the participation of one or more users in a chat or message thread. The artificial intelligence algorithm may be configured to determine when a chat or message thread has become abandoned. The time for a chat or message thread to be characterized as abandoned may be different for different chats or message threads. The artificial intelligence algorithm may use indications such as how frequently the users in the chat or message thread post in the chat or message thread, how frequently the users post in other chat or message threads, the relationship of the users in the chat or message thread, the topic of the chat or message thread, and the like to determine if the chat or message thread is abandoned. The artificial intelligence algorithm may improve the functioning of the chat system by increasing participation that would otherwise have been neglected. Further the artificial intelligence algorithm may reduce the rate of false positives by being configured to utilize more data points than other algorithms could, as described above.

The artificial intelligence algorithm may be configured to suggest a topic of conversation to encourage the users of the chat or message thread to continue interacting. For example, the artificial intelligence algorithm can suggest to a chat related to an upcoming meetup at a conference that has become dormant a series of restaurants near the conference center where the meetup can take place.

The artificial intelligence algorithm may be configured to determine which chats or message threads are to be revived. For example, the artificial intelligence algorithm can consider the relationship status between the members of a chat and not attempt to revive the chat if the members had recently broken up.

### Computer Systems

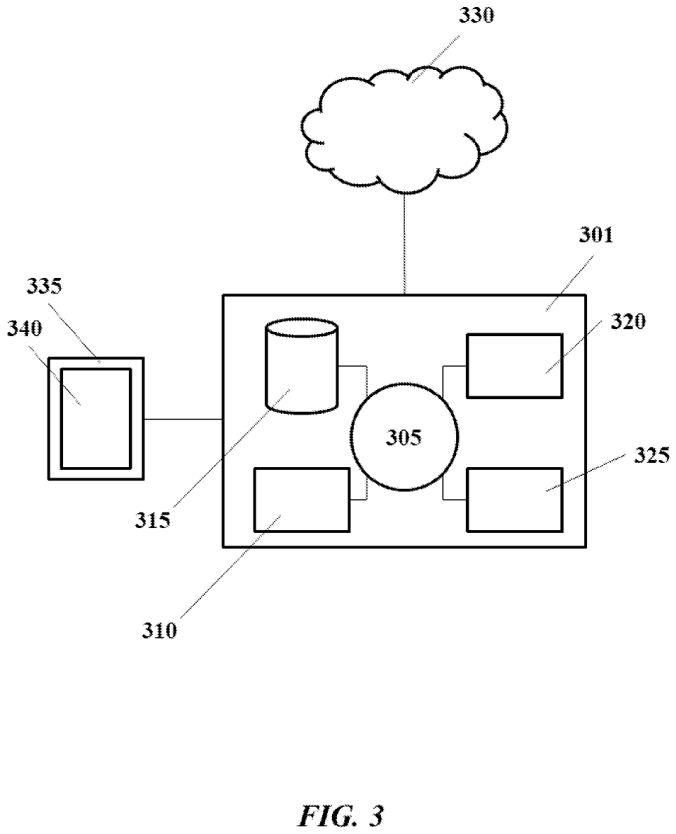

The present disclosure provides computer systems that are programmed to implement methods of the disclosure. FIG. 3 shows a computer system 301 that is programmed or otherwise configured to implement systems as described elsewhere herein. The computer system 301 can regulate various aspects of the present disclosure, such as, for example, the process 100 or FIG. 1 and/or the process 200 of FIG. 2. The computer system 301 can be an electronic device of a user or a computer system that is remotely located with respect to the electronic device. The electronic device can be a mobile electronic device.

The computer system 301 includes a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage and/or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet and/or extranet, or an intranet and/or extranet that is in communication with the Internet. The network 330 in some cases is a telecommunication and/or data network. The network 330 can include one or more computer servers, which can enable distributed computing, such as cloud computing. The network 330, in some cases with the aid of the computer system 301, can implement a peer-to-peer network, which may enable devices coupled to the computer system 301 to behave as a client or a server.

The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback.

The CPU 305 can be part of a circuit, such as an integrated circuit. One or more other components of the system 301 can be included in the circuit. In some cases, the circuit is an application specific integrated circuit (ASIC).

The storage unit 315 can store files, such as drivers, libraries, and saved programs. The storage unit 315 can store user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 330.

Methods as described herein can be implemented by way of machine (e.g., computer processor) executable code stored on an electronic storage location of the computer system 301, such as, for example, on the memory 310 or electronic storage unit 315. The machine executable or machine-readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 301 can include or be in communication with an electronic display 335 that comprises a user interface (UI) 340 for providing, for example, a portal to a social network. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305. The algorithm can, for example, be an artificial intelligence algorithm as described elsewhere herein.

### EXAMPLES

The following examples are illustrative of certain systems and methods described herein and are not intended to be limiting.

### Example 1

A user of a social media network has an upcoming birthday. The user has been a member of the social media network for two years, and in that time has posted a number of times about how much they enjoy brand X, a furniture company. Further, they spend a lot of time at the brand X company store near their home. Additionally, they have recently been taking surveys offered by brand X on their social media page about what coffee tables they want to see in their living room. An artificial intelligence algorithm is able to identify the user's upcoming birthday, and it deploys a natural language processing (NLP) algorithm to scan the user's page. The NLP algorithm finds a high number of posts about brand X. The artificial intelligence algorithm then generates a list of possible gifts for the user which include items made by brand X, along with other items made by similar manufactures. The artificial intelligence algorithm then ranks the items by their similarity to items that the user has previously expressed positive sentiment about in surveys they took on the social media network. The artificial intelligence algorithm then notifies two members of the user's family, along with three friends the user bought birthday gifts for in the last year. The artificial intelligence algorithm starts a group chat for the family and friends to discuss which item from the list they want to buy for the user. The list is sorted by relevance to the user, and tables made by brand X are shown to be highly relevant due to the user's previous interactions with brand X. The group settles on a coffee table that costs $500, which they decide to split evenly and have the table shipped to one of the friends to wrap for the user. The friends and family are each presented with a payment portal requesting $100 from each person. When all of the friends and family have paid, the artificial intelligence algorithm navigates to a list of pre-approved vendors, one of whom carries the coffee table. The algorithm places the order and directs the merchant to ship the table to the designated friend, who receives the item in due course.

### Example 2

A user Z of a social media network is planning an upcoming trip to Paris. Z searches for things to do in Paris, as well as airfare to get there. An artificial intelligence algorithm determines from these indications that Z is planning an upcoming trip and searches Z's friends on the social media network for someone who lives in Paris. When no friends were found to live in Paris, the artificial intelligence algorithm searches the friends of Z's friends, and locates two people who live in Paris, X and Y. The artificial intelligence algorithm next compares Z's interests with those of X and Y by using a natural language processing (NLP) algorithm to read Z, X, and Y's posts on the social media network. Further, the artificial intelligence algorithm uses a computer vision algorithm to process photographs posted by Z, X, and Y to the social media network, where the processing determines a similarity of the activities Z, X, and Y are performing in the photographs. The artificial intelligence algorithm then searches for similarities between Z, X, and Y's answers to various surveys and quizzes each have taken on the social media network. Aggregating all of this data, the artificial intelligence algorithm determines that Z and X both enjoy hiking and classical music but differ fundamentally on politics, while Z and Y have similar pollical leanings, as well as both enjoying cooking. Based on the weights the artificial intelligence algorithm has given the various data, the artificial intelligence algorithm determines that Z and Y are more compatible than Z and X. As such, the artificial intelligence algorithm notifies Z and Y's mutual friend W that it wants to introduce Z and Y. W, who has a knowledge of both Z and Y's personalities, decides that Z and Y would get along, so they instruct the artificial intelligence algorithm to introduce Z and Y. The artificial intelligence algorithm starts a chat session with Z and Y for the purpose of Y being able to inform Z about how to travel in Paris, as well as possibly take Z on a walking tour of the city. The artificial intelligence algorithm then updates the weights used for the various points of data based on the successful determination that Z and Y would be compatible, as reinforced by the ground truth of W's determination.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A method for generating a gift recommendation for a user of a social network, comprising:
(a) obtaining data about said user, which data comprises at least browsing history, messages and associations of said user on said social network;
(b) processing said data about said user with an artificial intelligence algorithm to predict a plurality of gifts relevant to said user, which artificial intelligence algorithm is a supervised learning algorithm trained at least in part on said data and a validation set comprising a list of gifts curated by said user or answers to a questionnaire provided to said user, thereby improving an accuracy of said artificial intelligence algorithm in predicting said plurality of gifts relevant to said user;
(c) presenting, in a graphical user interface, a list of said plurality of gifts to a plurality of other members of said social network who are associated with said user, wherein said list is configured to enable said plurality of other members to select a gift of said plurality of gifts, and wherein said plurality of other members are selected based at least in part on a history of gift giving between said user and said plurality of other members on said social network;
(d) providing a payment interface configured to enable said plurality of other members to pay a cost of said gift, wherein said payment interface is configured to charge said plurality of other members an equal amount for said gift; and
(e) upon receiving payment from said plurality of other members, automatically placing an order for said gift with an online merchant that offers said gift.

2. The method of claim 1, wherein said associations comprise one or more of likes, shares, page views, interactions, or check-ins on said social network.

3. The method of claim 1, wherein said messages comprise posts and private messages on said social network.

4. The method of claim 3, wherein said posts comprise images.

5. The method of claim 1, wherein said data further comprises audio and video chats on said social network.

6. The method of claim 1, wherein said data comprises survey data from said user.

7. The method of claim 1, wherein said artificial intelligence algorithm comprises a natural language processing algorithm.

8. (canceled)

9. The method of claim 1, wherein (c) comprises selecting said plurality of other members based on a relationship to said user or an interaction with said user.

10. (canceled)

11. One or more non-transitory computer storage media storing instructions that are operable, when executed by one or more computers, to cause said one or more computers to perform operations comprising:
(a) obtaining data about a user of a social network, which data comprises at least browsing history, messages and associations of said user on said social network;
(b) processing said data about said user with an artificial intelligence algorithm to predict a plurality of gifts relevant to said user, which artificial intelligence algorithm is a supervised learning algorithm trained at least in part on said data and a validation set comprising a list of gifts curated by said user or answers to a questionnaire provided to said user, thereby improving an accuracy of said artificial intelligence algorithm in predicting said plurality of gifts relevant to said user;
(c) presenting, in a graphical user interface, a list of said plurality of gifts to a plurality of other members of said social network who are associated with said user, wherein said list is configured to enable said plurality of other members to select a gift of said plurality of gifts, and wherein said plurality of other members are selected based at least in part on a history of gift giving between said user and said plurality of other members on said social network;
(d) providing a payment interface configured to enable said plurality of other members to pay a cost of said gift, wherein said payment interface is configured to charge said plurality of other members an equal amount for said gift; and
(e) upon receiving payment from said plurality of other members, automatically placing an order for said gift with an online merchant that offers said gift.

12.-18. (canceled)

19. The method of claim 1, wherein said social network is a private social network.

20. The method of claim 1, wherein said data about said user further comprises location data.

21. The method of claim 1, wherein said list of said plurality of gifts comprises at least about 3 gifts.

22. The method of claim 1, wherein said processing comprises using a dichotomous key hierarchical organization method.

23. The method of claim 1, further comprising, subsequent to (c), updating said list of said plurality of gifts one or more times.

24. The method of claim 23, wherein said updating is based on additional data obtained about said user.

25. The method of claim 9, wherein said artificial intelligence algorithm is updated based on a response of said plurality of other members to being presented with said list.
